(19) United States
(12) Patent Application Publication
(10) Pub. No.: US 2026/0166721 A1
(43) Pub. Date: Jun. 18, 2026

(54) VIRTUAL COMMISSIONING AND SIMULATION METHOD FOR INDUSTRIAL ROBOTS BASED ON DIGITAL TWIN

(71) Applicant: Beijing Research Institute of Automation for Machinery Industry Co., Ltd., Beijing (CN)

(72) Inventors: Minghao DUAN, Beijing (CN); Weicai CHEN, Beijing (CN); Dequan WANG, Beijing (CN); Nan ZHANG, Beijing (CN); Nan ZHAO, Beijing (CN); Shun ZHANG, Beijing (CN); Lixun LIU, Beijing (CN); Zhenyu XIE, Beijing (CN)

(21) Appl. No.: 19/534,926

(22) Filed: Feb. 10, 2026

(30) Foreign Application Priority Data
Mar. 19, 2025 (CN) 202510323915.4

(51) Int. Cl. B25J 9/16

(52) U.S. Cl. CPC B25J 9/1605; B25J 9/1671; G05B 2219/35151; G05B 2219/39001

(57) ABSTRACT

An industrial robot virtual commissioning and simulation method based on digital twin, in which a digital twin model of an industrial robot is established; a kinematic model of the industrial robot is established, and a forward kinematics analysis and an inverse kinematics analysis are performed on the kinematics model; the digital twin model is associated with a signal of the industrial robot to perform virtual commissioning and digital twin-based virtual-real mapping; and digital twin visualization of the industrial robot is realized.

### CROSS-REFERENCE TO RELATED APPLICATIONS

This application claims the benefit of priority from Chinese Patent Application No. 202510323915.4, filed on Mar. 19, 2025. The content of the aforementioned application, including any intervening amendments thereto, is incorporated herein by reference in its entirety.

### TECHNICAL FIELD

This application relates to commissioning and simulation technologies for industrial robots, and more particularly to a virtual commissioning and simulation method for industrial robots based on digital twin.

### BACKGROUND

With the integration of new-generation information technology and manufacturing industry, the intelligent automation has received widespread interest in the current manufacturing industry. Industrial robots exhibit remarkable advantages in terms of flexibility, repeatability and new functionality support, and can effectively reduce the cost and improve production efficiency and product quality. Therefore, the industrial robot has become a notable sign for the automation and intelligence of the manufacturing industry.

Currently, there are two programming modes for robots (i.e., online programming and offline programming). The online programming mode takes up the actual working time of a robot, and requires manual teaching, resulting in low efficiency and poor accuracy. Thus, the online programming mode fails to satisfy the requirements of the current manufacturing industry. Regarding the offline programming mode, a three-dimensional model of the physical robot and its working environment is constructed in a virtual environment, and transmitted to a physical system together with a simulation environment and a program that are constructed in an offline simulation process. Under the offline programming mode, the physical robot system environment is separated from a programming environment, so as to avoid potential safety hazards in some dangerous scenarios. Compared to the online programming mode, the offline programming mode does not occupy production resources and saves labor costs.

However, due to the information independence between a real space and a virtual space, data cannot be fed from the physical robot back to a virtual simulation system in real time. Similarly, any adjustments made to the robot parameters in the virtual environment cannot be quickly synchronized to the physical system. Moreover, any changes to the production line will require re-design of the operation process, thereby increasing the manufacturing cost.

### SUMMARY

The present disclosure provides a virtual commissioning and simulation method for an industrial robot based on digital twin to address the aforementioned problems in the prior art. Specifically, a digital twin model highly consistent with the industrial robot and its working environment is established in a virtual environment, and a real-time communication between the digital twin model and the industrial robot is further established, so as to enable the comprehensive commissioning of the industrial robot and its peripheral devices in the virtual environment. Moreover, the operation state of the physical industrial robot is mapped to the digital twin model to enable the comprehensive simulation of the industrial robot and its operation state, thereby effectively enhancing the simulation accuracy and adaptability of industrial robot.

In order to achieve the above object, the following technical solutions of the present disclosure are adopted.

A virtual commissioning and simulation method for an industrial robot based on digital twin, comprising:
(S1) establishing a digital twin model of the industrial robot;
(S2) establishing a kinematic model of the industrial robot, and performing a forward kinematics analysis and an inverse kinematics analysis on the kinematics model;
(S3) associating the digital twin model of the industrial robot with a signal of the industrial robot to perform virtual commissioning and digital twin-based virtual-real mapping; and
(S4) realizing digital twin visualization of the industrial robot.

In some embodiments, step (S1) is performed through steps of:
selecting and inputting a type of the industrial robot to establish a geometric model, or establishing the geometric model based on a geometric dimension of the industrial robot; and
setting material, color, shape and structure of the geometric model to be identical to those of the industrial robot to establish the digital twin model having a visual and structural twin relationship with the industrial robot.

In some embodiments, in step (S2), the forward kinematics analysis is performed through steps of:
when all joint angles and link parameters of the industrial robot are determined, determining a pose of an end effector of the industrial robot, which is represented by a homogeneous transformation matrix

$${}_{0}^{6} T ,$$

expressed as:

$${}_{0}^{6} T = {}_{0}^{1} T * {}_{1}^{2} T * {}_{2}^{3} T * {}_{3}^{4} T * {}_{4}^{5} T * {}_{5}^{6} T = [ \begin{matrix}{n}_{x} & {o}_{x} & {a}_{x} & {p}_{x} \\ {n}_{y} & {o}_{y} & {a}_{y} & {p}_{y} \\ {n}_{z} & {o}_{z} & {a}_{z} & {p}_{z} \\ 0 & 0 & 0 & 1\end{matrix} ] ; \qquad ( 1 )$$

wherein

$${}_{0}^{6} T$$

represents a pose of a sixth joint coordinate system relative to a base coordinate system;

$${}_{i - 1}^{i} T ( i = 1 , 2 , … , 6 )$$

represents a homogeneous transformation matrix from a (i−1)-th joint coordinate system to an i-th joint coordinate system; (nₓ, n_{y}, n_{z}) represents an X-axis direction of an end effector coordinate system; (oₓ, o_{y}, o_{z}) represents a Y-axis direction of the end effector coordinate system; (aₓ, a_{y}, a_{z}) represents a Z-axis direction of the end effector coordinate system; and (pₓ, p_{y}, p_{z}) represents a position of an end effector;
describing a relative relationship between two adjacent links with four parameters, wherein the four parameters are link length aᵢ, link twist aᵢ, link offset dᵢ and joint angle θᵢ, respectively; the link offset dᵢ represents a distance from an origin of the (i−1)-th joint coordinate system to an intersection point between a Zᵢ₋₁ axis and an Xᵢ axis along the Zᵢ₋₁ axis; the link length aᵢ represents a length of a common normal between an axis of an i-th joint and an axis of a (i+1)-th joint; the link twist aᵢ represents an angle between the axis of the i-th joint and the axis of the (i+1)-th joint on a plane formed by the axis of the i-th joint and the link length aᵢ; the joint angle θᵢ represents a joint angle rotating about the Zᵢ₋₁ axis from an Xᵢ₋₁ axis to the Xᵢ axis; i=1,2, . . . ,6 and an initial value of the joint angle θᵢ represents an angle of each joint of the industrial robot in an initial state;
based on definitions of the link length aᵢ, the link twist aᵢ, the link offset dᵢ and the joint angle θᵢ, establishing a pose transformation from the (i−1)-th joint coordinate system to the i-th joint coordinate system, expressed as a matrix

$${}_{i - 1}^{i} T ,$$

expressed as:

$${}_{i - 1}^{i} T = Trans ( {Z}_{i - 1} , {d}_{i} ) Rot ( {Z}_{i - 1} , {θ}_{i} ) Trans ( {X}_{i} , {l}_{i} ) Rot ( {X}_{i} , {α}_{i} ) = [ \begin{matrix}cos {θ}_{i} & - sin {θ}_{i} & 0 & {α}_{i - 1} \\ sin {θ}_{i} cos {α}_{i - 1} & cos {θ}_{i} cos {α}_{i - 1} & - sin {α}_{i - 1} & - {d}_{i} sin {α}_{i - 1} \\ sin {θ}_{i} sin {α}_{i - 1} & cos {θ}_{i} sin {α}_{i - 1} & - cos {α}_{i - 1} & - {d}_{i} cos {α}_{i - 1} \\ 0 & 0 & 0 & 1\end{matrix} ] ; \qquad ( 2 )$$

wherein Trans(X, l) represents a translational transformation, indicating a translation of l units along a positive direction of the X-axis; Rot(X, θ) represents a rotational transformation, indicating a rotation of θ degrees about the positive direction of the X-axis; and
obtaining the homogeneous transformation matrix

$${}_{0}^{6} T$$

of the end effector at a key point by combing formulas (1) and (2).

In some embodiments, in step (S2), the inverse kinematics analysis is performed through steps of
reversely solving the joint angle θᵢ through the homogeneous transformation matrix

$${}_{0}^{6} T$$

of the end effector; and
isolating a position parameter expression and an orientation parameter expression of the industrial robot from the formula (2);
wherein first three joint coordinate system transformation matrices in formula (1) are left-multiplied to a left side of the formula (1), expressed as:

$${}_{2}^{3} {T}^{- 1} * {}_{1}^{2} {T}^{- 1} * {}_{0}^{1} {T}^{- 1} * {}_{0}^{6} T = {}_{3}^{4} T * {}_{4}^{5} T * {}_{5}^{6} T ; \qquad ( 3 )$$

performing block-wise comparison on matrices on both sides of the formula (3) to obtain an equation set, expressed as:

$$\{ \begin{matrix}{s}_{1} {p}_{x} & = {c}_{1} {p}_{y} \\ {a}_{3} & = {s}_{23} ( {d}_{1} - {p}_{z} - {a}_{2} {s}_{2} ) - {c}_{23} ( {a}_{1} + {a}_{2} {c}_{2} - {s}_{1} {p}_{y} - {c}_{1} {p}_{x} ) \\ {d}_{4} & = {s}_{23} ( {a}_{1} + {a}_{2} {c}_{2} - {s}_{1} {p}_{y} - {c}_{1} {p}_{x} ) + {c}_{23} ( {d}_{1} - {p}_{z} - {a}_{2} {s}_{2} ) \\ {s}_{4} {s}_{5} & = {s}_{1} {a}_{x} - {c}_{1} {a}_{y} \\ {c}_{4} {s}_{5} & = {c}_{23} {c}_{1} {a}_{x} + {s}_{23} {s}_{1} {a}_{y} - {s}_{23} {a}_{z} \\ {c}_{5} & = {s}_{23} {c}_{1} {n}_{x} - {s}_{23} {c}_{1} {n}_{y} - {c}_{23} {n}_{z} \\ {s}_{5} {s}_{6} & = {s}_{23} {c}_{1} {o}_{x} + {s}_{23} {s}_{1} {o}_{y} + {c}_{23} {o}_{yz}\end{matrix} , \qquad ( 4 )$$

wherein sᵢ=sin θᵢ, cᵢ=cos θᵢ, sᵢⱼ=sin(θᵢ+θⱼ), cᵢⱼ=cos(θᵢ+θⱼ)(i=1,2, . . . ,6)(j=1,2, . . . ,6);
introducing an arctan 2(y/x) function to solve for θ in formula (4) to obtain eight sets of solutions for six joint angles, wherein each equation of the formula (4) is expressed as:

$$a sin {θ}_{i} + b cos {θ}_{i} = c ; \qquad ( 5 )$$

if a, b, and c in formula (5) are continuous, the formula (5) has a solution on the premise of a²+b²>c², expressed as:

$${θ}_{i} = arctan2 ( c \pm \sqrt{{a}^{2} + {b}^{2} - {c}^{2}} ) - arctan2 ( b , a ) ; \qquad ( 6 )$$

and
obtaining the eight sets of solutions by combining the formula (4), the formula (5) and the formula (6).

In some embodiments, a principle for obtaining an optimal solution from the eight sets of solutions is expressed as:

$${θ}_{ij} = Min \{ {\sum }_{i = 1}^{3} {( {θ}_{ij} - {θ}_{i}^{′} )}^{2} \} ; \qquad ( 7 )$$

wherein θᵢⱼ represents a j-th solution of an i-th joint, and

$${θ}_{i}^{′}$$

represents an angle of the i-th joint at a previous point.

In some embodiments, steps (S3) comprises:
assigning a process attribute to the digital twin model by process simulation, such that each process action of the digital twin model has a corresponding motion process logic;
performing a timing simulation on the process attribute of the industrial robot using a timing editor to plan a sequence of individual processes based on an action sequence table;
enabling a synchronous mapping between the industrial robot and the digital twin model;
establishing a real-time communication between the industrial robot and the digital twin model;
in a case that a control unit of the industrial robot is a communication server, enabling a virtual-to-real mapping, wherein the industrial robot is configured to transmit joint data in real time to the digital twin model, and the digital twin model is configured to receive the joint data and perform steps (S1-S2) to achieve a synchronous motion; and
in a case that the control unit of the digital twin model is the communication server, enabling a virtual-to-real control, wherein the digital twin model is configured to send a control command to the control unit of the industrial robot, and the industrial robot is configured to receive and execute the control command.

In some embodiments, the timing simulation is performed based on time.

Compared to the prior art, the present disclosure has the following beneficial effects.

Regarding the digital twin-based industrial robot virtual commissioning and simulation method provided herein, a digital twin model of an industrial robot is established; a kinematic model of the industrial robot is established, and a forward kinematics analysis and an inverse kinematics analysis are performed on the kinematic model; the digital twin model is associated with a signal of the industrial robot to perform virtual commissioning and digital twin-based virtual-real mapping; and the digital twin visualization of the industrial robot is realized. In summary, a digital twin model highly consistent with the industrial robot and its working environment is established in a virtual environment, and a real-time communication between the digital twin model and the industrial robot is further established, so as to enable the comprehensive commissioning of the industrial robot and its peripheral devices in the virtual environment. Moreover, the operation state of the physical industrial robot is mapped to the digital twin model to enable the comprehensive simulation of the industrial robot and its operation state, thereby effectively enhancing the simulation accuracy and adaptability of industrial robot.

### BRIEF DESCRIPTION OF THE DRAWINGS

In order to illustrate the technical solutions more clearly, the accompanying figures needed in the description of the embodiments are briefly introduced.

FIG. 1 is flowchart of a virtual commissioning and simulation method for an industrial robot based on digital twin according to an embodiment of the present disclosure;

FIG. 2 structurally shows a six-degree-of-freedom industrial robot according to an embodiment of the present disclosure;

FIG. 3 is a diagram of a relationship between link joint axis of the industrial robot according to an embodiment of the present disclosure;

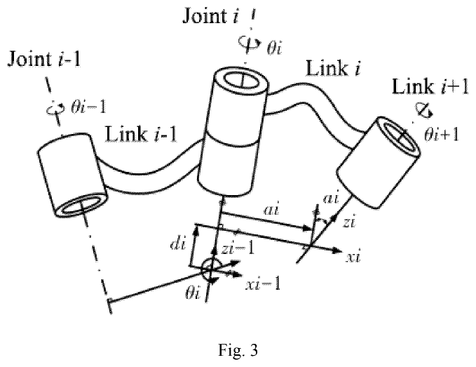

FIG. 4 is a software screenshot of a Home point setup of the industrial robot according to an embodiment of the present disclosure;

FIG. 5 is an action sequence table of the industrial robot according to an embodiment of the present disclosure; and

FIG. 6 is a flowchart of a signal connection of the industrial robot according to an embodiment of the present disclosure.

### DETAILED DESCRIPTION OF EMBODIMENTS

The embodiments of the present disclosure will be detailly described below. Examples of the embodiments are shown in the accompanying figures. The same or similar labels in the accompanying drawings of the present disclosure correspond to the same or similar components. It should be understood that the embodiments disclosed herein are merely illustrative of the disclosure, and are not intended to limit the present disclosure.

The embodiments of the present disclosure are detailly described below with reference to the accompanying figures.

It should be noted that a virtual environment provided herein includes a component, a control unit and a system related to a digital twin model.

The present disclosure provides a virtual commissioning and simulation method for an industrial robot based on digital twin.

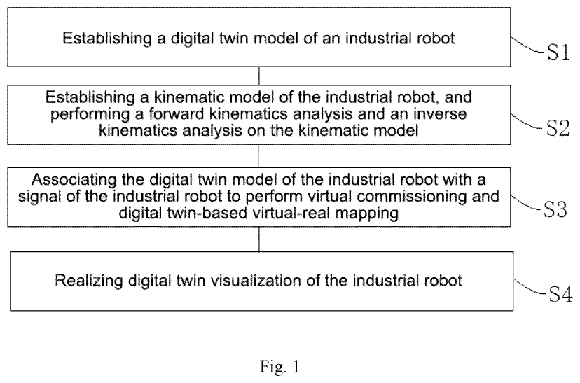

Referring to FIG. 1, the method is performed through the following steps.

(S1) A digital twin model of the industrial robot is established.

In some embodiments, there are two approaches to establish a geometric model of the digital twin model of the industrial robot. One approach is directly selecting and inputting a type of the industrial robot to establish the geometric model, and the other approach is establishing the geometric model based on a geometric dimension of the industrial robot. The geometric model includes component model and production line model. The material of the geometric model is set to be identical to that of the industrial robot, so as to ensure high consistency between geometric dimension, material attribute, color and shape of the geometric model and those of the industrial robot. The digital twin model is enabled to have a visual and structural twin relationship with the industrial robot, so as to truly reflect assembly relationship, origin position and subordinate relationship of the industrial robot in an actual working environment.

(S2) A kinematics model of the industrial robot is established, and a forward kinematics analysis and an inverse kinematics analysis are performed on the kinematics model, thereby forming the execution entity that anables the subsequent virtual-real mapping and digital twin visualization.

In some embodiments, a positive direction of link motion, a selection rule of a reference coordinate system and an offset thereof in the virtual environment are consistent with those in an actual situation, so that the industrial robot is capable of motion simulation, where the motion simulation is configured to simulate translational or rotational change between links (depending on a type of a joint axis for a robot). A trajectory planning process of the industrial robot is configured to comply with a kinematic constraint, which is represented by an angle interpolation and a velocity interpolation in a joint space or an interpolation of a pose of an end effector in a Cartesian space.

In order to determine all joint angles of the end effector at a key point, a kinematics expression analysis is performed on the industrial robot, where the kinematics expression analysis includes a process of establishing the kinematic model and a process of solving a forward kinematics and an inverse kinematics. The process of solving the forward kinematics is configured to calculate a homogeneous transformation matrix of an end effector coordinate system relative to a base coordinate system through all joint angles and link parameters (i.e., a rotation angle), so as to monitor operational status of the industrial robot in real time. The process of solving the inverse kinematics is configured to convert a point in the Cartesian space into an angle in the joint space. The industrial robot often needs to plan a path based on the pose of the industrial robot in the Cartesian coordinate system when performing a task at an industrial site. Therefore, the process of solving the inverse kinematics plays an important role in the trajectory planning process.

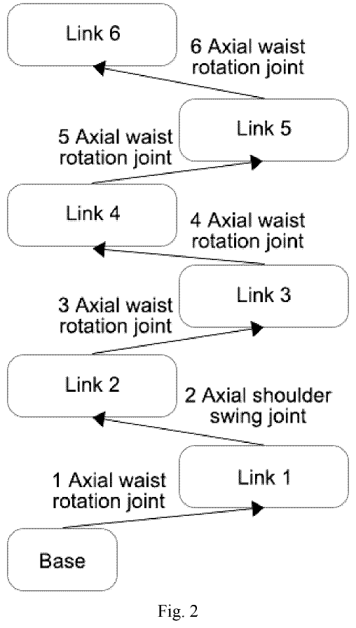

It should be noted that, taking a six-degree-of-freedom industrial robot as an example in this embodiment, the method disclosed herein is illustrated with reference to FIG. 2.

The process of solving the inverse kinematics for the six-degree-of-freedom industrial robot is typically performed with a numerical method and an analytical method. The numerical method is realized by an iterative computation with a significant computational burden, resulting in a slower solving speed than the analytical method. However, if the six-degree-of-freedom industrial robot satisfies a Pieper principle, there is an analytical solution that satisfies a related condition. A Denavit-Hartenberg (D-H) method is adopted to perform the process of establishing the kinematic model and the process of solving the inverse kinematics.

A forward kinematics analysis is performed through the following steps.

When all joint angles and link parameters of the industrial robot are determined, the pose of the end effector of the industrial robot is determined, which is represented by a homogeneous transformation matrix

$${}_{0}^{6} T ,$$

expressed as:

$${}_{0}^{6} T = {}_{0}^{1} T * {}_{1}^{2} T * {}_{2}^{3} T * {}_{3}^{4} T * {}_{4}^{5} T * {}_{5}^{6} T = [ \begin{matrix}{n}_{x} & {o}_{x} & {a}_{x} & {p}_{x} \\ {n}_{y} & {o}_{y} & {a}_{y} & {p}_{y} \\ {n}_{z} & {o}_{z} & {a}_{z} & {p}_{z} \\ 0 & 0 & 0 & 1\end{matrix} ] ; \qquad ( 1 )$$

where

$${}_{0}^{6} T$$

represents a pose of a sixth joint coordinate systems relative to a base coordinate system;

$${}_{i - 1}^{i} T ( i = 1 , 2 , … , 6 )$$

represents a homogeneous transformation matrix from a (i−1)-th joint coordinate system to an i-th joint coordinate system; (nₓ, n_{y}, n_{z}) represents an X-axis direction of an end effector coordinate system; (oₓ, o_{y}, o_{z}) represents a Y-axis direction of the end effector coordinate system; (aₓ, a_{y}, a_{z}) represents a Z-axis direction of the end effector coordinate system; and (pₓ, p_{y}, p_{z}) represents a position of an end effector.

A relative relationship between two adjacent links with four parameters is described, where the four parameters are link length aᵢ, link twist aᵢ, link offset dᵢ and joint angle θᵢ, respectively. The link offset dᵢ represents a distance from an origin of the (i−1)-th joint coordinate system to an intersection point between a Zᵢ₋₁ axis and an X, axis along the Zᵢ₋₁ axis. The link length a₁ represents a length of a common normal between an axis of an i-th joint and an axis of a (i+1)-th joint. The link twist aᵢ represents an angle between the axis of the i-th joint and the axis of the (i+1)-th joint on a plane formed by the axis of the i-th joint and the link length aᵢ. The joint angle θᵢ represents a joint angle rotating about the Zᵢ₋₁ axis from an Xᵢ₋₁ axis to the Xᵢ axis. i=1,2, . . . ,6 and an initial value of the joint angle θᵢ represents an angle of each joint of the industrial robot in an initial state.

Based on definitions of the link length aᵢ, the link twist aᵢ, the link offset dᵢ and the joint angle θᵢ, a pose transformation from the (i−1)-th joint coordinate system to the i-th joint coordinate system is established, expressed as

$${}_{i - 1}^{i} T : {}_{i - 1}^{i} T = Trans ( {Z}_{i - 1} , {d}_{i} ) Rot ( {Z}_{i - 1} , {θ}_{i} ) Trans ( {X}_{i} , {l}_{i} ) Rot ( {X}_{i} , {α}_{i} ) = [ \begin{matrix}cos {θ}_{i} & - sin {θ}_{i} & 0 & {α}_{i - 1} \\ sin {θ}_{i} cos {α}_{i - 1} & cos {θ}_{i} cos {α}_{i - 1} & - sin {α}_{i - 1} & - {d}_{i} sin {α}_{i - 1} \\ sin {θ}_{i} sin {α}_{i - 1} & cos {θ}_{i} sin {α}_{i - 1} & - cos {α}_{i - 1} & - {d}_{i} cos {α}_{i - 1} \\ 0 & 0 & 0 & 1\end{matrix} ] , \qquad ( 2 )$$

where Trans(X, l) represents a translational transformation, indicating a translation of 1 units along a positive direction of the X-axis; and Rot(X, θ) represents a rotational transformation, indicating a rotation of θ degrees about the positive direction of the X-axis.

The homogeneous transformation matrix

$${}_{0}^{6} T$$

of the end effector at a key point is obtained by combing formulas (1) and (2).

An inverse kinematics analysis is performed through the following steps.

The joint angle θᵢ is reversely solved through the homogeneous transformation matrix

$${}_{0}^{6} T$$

of the end effector.

A position parameter expression and an orientation parameter expression of the industrial robot are isolated from the formula (2).

First three joint coordinate system transformation matrices in formula (1) are left-multiplied to a left side of the formula (1), expressed as:

$${}_{2}^{3} {T}^{- 1} * {}_{1}^{2} {T}^{- 1} * {}_{0}^{1} {T}^{- 1} * {}_{0}^{6} T = {}_{3}^{4} T * {}_{4}^{5} T * {}_{5}^{6} T . \qquad ( 3 )$$

Block-wise comparison is performed on matrices on both sides of the formula (3) to obtain an equation set, expressed as:

$$\{ \begin{matrix}{s}_{1} {p}_{x =} {c}_{1} {p}_{y} \\ {a}_{3} = {s}_{23} ( {d}_{1} - {p}_{z} - {a}_{2} {s}_{2} ) - {c}_{23} ( {a}_{1} + {a}_{2} {c}_{2} - {s}_{1} {p}_{y} - {c}_{1} {p}_{x} ) \\ {d}_{4} = {s}_{23} ( {a}_{1} + {a}_{2} {c}_{2} - {s}_{1} {p}_{y} - {c}_{1} {p}_{x} ) + {c}_{23} ( {d}_{1} - {p}_{z} - {a}_{2} {s}_{2} ) \\ {s}_{4} {s}_{5} = {s}_{1} {a}_{x} - {c}_{1} {a}_{y} \\ {c}_{4} {s}_{5} = {c}_{23} {c}_{1} {a}_{x} + {s}_{23} {s}_{1} {a}_{y} - {s}_{23} {a}_{z} \\ {c}_{5} = {s}_{23} {c}_{1} {n}_{x} - {s}_{23} {c}_{1} {n}_{y} - {c}_{23} {n}_{z} \\ {s}_{5} {s}_{6} = {s}_{23} {c}_{1} {o}_{x} + {s}_{23} {s}_{1} {o}_{y} + {c}_{23} {o}_{yz}\end{matrix} , \qquad ( 4 )$$

where sᵢ=sin θᵢ, cᵢ=cos θᵢ, sᵢⱼ=sin(θᵢ+θⱼ), cᵢⱼ=cos(θᵢ+θⱼ) (i=1,2, . . . ,6) (j=1,2, . . . ,6).

An arctan 2(y/x) function is introduced to solve for θ in formula (4) to obtain eight sets of solutions for six joint angles, where each equation of the formula (4) is expressed as:

$$a sin {θ}_{i} + b cos {θ}_{i} = c . \qquad ( 5 )$$

If a, b, and c in formula (5) are continuous, the formula (5) has a solution on the premise of a²+b²>c², expressed as:

$${θ}_{i} = arctan2 ( c \pm \sqrt{{a}^{2} + {b}^{2} - {c}^{2}} ) - arctan2 ( b , a ) . \qquad ( 6 )$$

The eight sets of solutions are obtained by combining the formula (4), the formula (5) and the formula (6).

Since the offset of first three joint angles has a greater impact on the end effector, it is necessary to ensure that the difference between current angles of the first three joint angles and the angles at the previous key point is minimized. A least squares method is adopted to obtain the optimal solution that satisfies the related condition, so as to optimize operation time and energy efficiency. The pose of the end effector at the key point is translated into the joint angle through this process.

A principle for obtaining an optimal solution from the eight sets of solutions is expressed as:

$${θ}_{ij} = Min \{ {\sum }_{i = 1}^{3} {( {θ}_{ij} - {θ}_{i}^{′} )}^{2} \} , \qquad ( 7 )$$

where θᵢⱼ represents a j-th solution of an i-th joint, and

$${θ}_{i}^{′}$$

represents an angle of the i-th joint at a previous point.

(S3) The digital twin model of the industrial robot is associated with a signal of the industrial robot to perform virtual commissioning and digital twin-based virtual-real mapping.

In some embodiments, step (S3) is performed through the following steps,

(S31) A process attribute is assigned to the digital twin model by process simulation method, such that each process action of the digital twin model has corresponding motion possess logic.

In some embodiments, the process attribute is assigned to the digital robot by process simulation method. The process attribute includes opening and closing of a gripper, and grasping path when the industrial robot grasps a workpiece, and angle and angular speed of a rotary table while rotating, such that each process action of the industrial robot has the corresponding motion process logic.

As known from the inverse kinematics of the industrial robot, a mapping, from a terminal position of the industrial robot to a joint position of the industrial robot, is very complicated. Consequently, especially for a multiple-degree-of-freedom industrial robot, there is no analytical solution sometimes. To avoid generating a singular solution, a transition point is appropriately added when defining the process of the industrial robot.

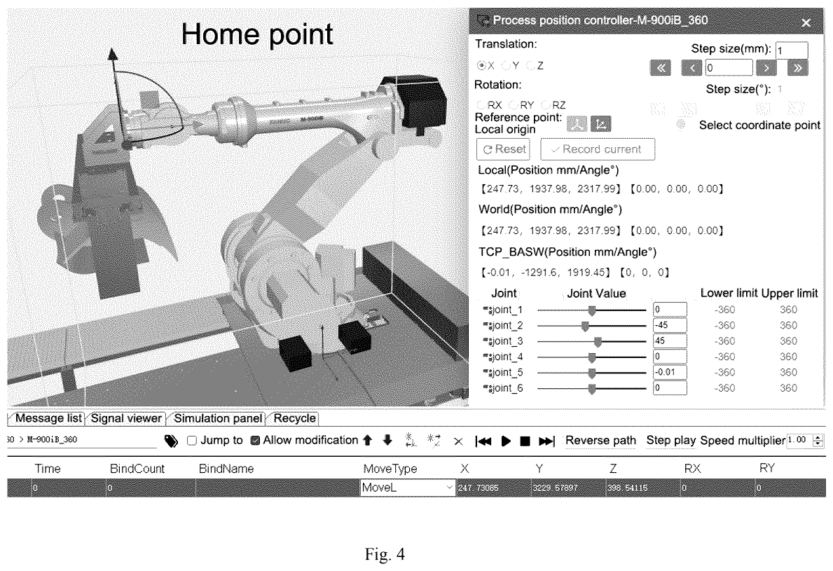

Referring to FIG. 4, the following points are set during the motion process of the industrial robot, including a Home point, a first transition point 1, a transition point 2, a grasping point and a Via_5 point.

The Home point is configured to change an initial state of the industrial robot to a new state when generating the singular solution during the motion process of the industrial robot. The first transition point 1 is established at a middle position between the Home point to a grasping point to prevent the industrial robot from encountering a collision point or a limit point during the motion process of the industrial robot. At the first transition point 1, the end effector of the industrial robot is rotated 600 about the Z-axis. The second transition point 2 is set directly above the grasping point, and is configured to allow the gripper of the industrial robot to align with the grasping point. The grasping point is configured to grasp the workpiece. The Via_5 point is configured to prevent the industrial robot from colliding with a machining center.

The process of the industrial robot is configured as follows. The industrial robot moves from the Home point to the first transition point 1, then to the second transition point 2, and finally to the grasping point. After the workpiece is grasped, the industrial robot returns from the grasping point to the second transition point 2, then back to the first transition point 1, and finally to the Home point, so as to ensure a smooth grasping path through the process of the industrial robot.

(S32) A timing simulation is performed on the process attribute of the industrial robot using a timing editor to plan a sequence of individual processes based on an action sequence table.

In some embodiments, after defining the process attribute of the industrial robot, the timing simulation is performed by using the timing editor. The sequence of individual processes is planned based on the action sequence table. Rationality of the production process is verified through the timing simulation.

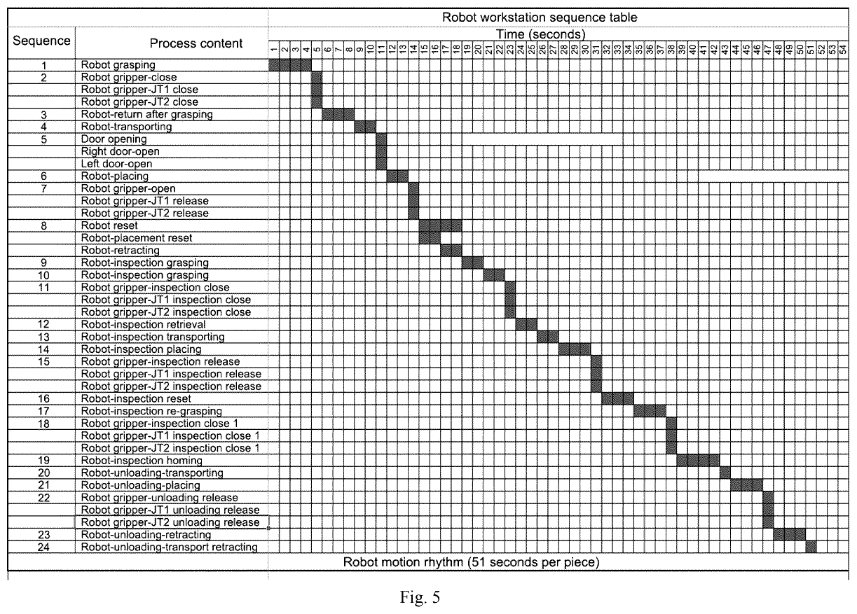

Referring to FIG. 5, the timing simulation is performed based on time.

(S33) Asynchronous mapping between the industrial robot and the digital twin model is enabled.

(S34) A real-time communication between the industrial robot and the digital twin model is established.

In some embodiments, Transmission Control Protocol/Internet Protocol (TCP/IP) are adopted for a communication between the industrial robot and the virtual environment. A Socket programming interface is utilized to transmit the joint data in real time. Steps (S1-S2) are performed on a virtual model to achieve a synchronous motion of the virtual digital twin model and a binding of the virtual digital twin model with the real joint data.

In a case that a control unit of the industrial robot is a communication server, a virtual-to-real mapping is enabled, where the industrial robot is configured to transmit joint data in real time to the digital twin model, and the digital twin model is configured to receive the joint data and perform steps (S1-S2) to achieve a synchronous motion.

In a case that the control unit of the digital twin model is the communication server, a virtual-to-real control is enabled, where the digital twin model is configured to send a control command to the control unit of the industrial robot, and the industrial robot is configured to receive and execute the control command.

In some embodiments, acquired real-time data is categorized into a real-time position data and a real-time signal data. The real-time position data is selected from the group consisting of joint angle, joint velocity, pose of the end effector and a combination thereof during the motion of the industrial robot. The real-time signal data includes, but is not limited to, a signal from a Programmable Logic Controller (PLC).

In some embodiments, signal configuration mainly includes a signal name, a type, an address, an index, a Controlled Model Identifier (ID) and an International Electrotechnical Commission (IEC) format.

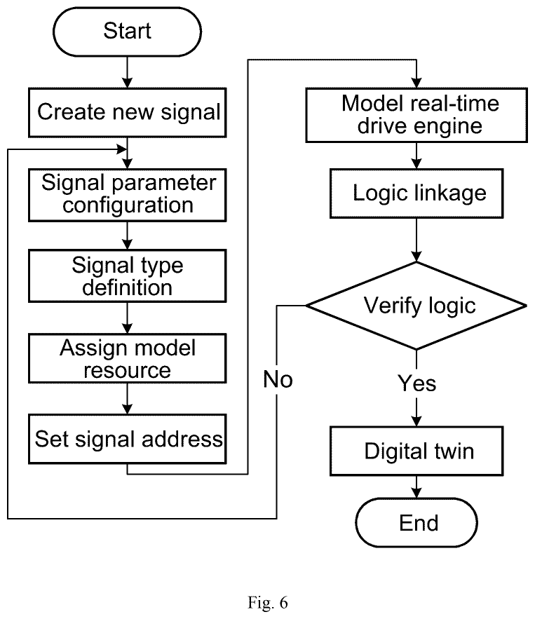

Referring to FIG. 6, a signal connection process is performed through steps of creating a new signal, setting a signal parameter, defining a signal type, assigning a model resource, setting a signal address, performing a logic linkage and enabling a digital twin.

(S4) Digital twin visualization of the industrial robot is realized.

The digital twin visualization is achieved based on the model established in step (S1), the kinematics analysis in step (S2) and the real-time data obtained in step (S3), so as to exhibit precise mapping relationships and physical significance. Step 4 (Digital Twin Visualization) integrates all the technical features of the preceding steps, ultimately achieving a dynamic, synchronized, and interactive digital mapping of the physical world.

In some embodiments, after performing the kinematics definition, process simulation, timing simulation and data signal communication on the model of the industrial robot, digital twin-based scene is issued to realize digital twin-based effect of a real-time dynamic mapping of the operational status of the industrial robot. The digital twin-based scene is configured to have the motion process logic and to be driven by real-time data signal.

By means of the technical solutions proposed herein, the real time monitoring and remote control can be effectively achieved, exhibiting remarkable practical significance. Specifically, based on the data acquisition and transmission method provided herein, the real time operational data of the physical robot (such as joint position and orientations, torque, operational status, and sensor information) can be safely and reliably synchronized to a remote monitoring terminal, thereby enabling the multi-dimensional and real-time visualization of the operational status of the physical robot. Users can, remotely and in real time, adjust motion trajectories and working parameters of the robot, as well as issue commands via this terminal, enabling precise remote control.

As used herein, “an embodiment”, “some embodiments”, “an example”, “specific examples”, “some examples” or similar phrases mean that a specific feature, structure, material or characteristic described with reference to the embodiment is included in one or more embodiments of the present disclosure. The above illustrative expressions do not necessarily refer to the same embodiment or example. Moreover, the specific feature, structure, material or characteristic described herein can be combined in an appropriate method in any one or more of the embodiments or examples.

Described above are merely preferred embodiments of the present disclosure, which are not intended to limit the present disclosure. It should be understood that various modifications and improvements made by those skilled in the art without departing from the spirit of the disclosure shall fall within the scope of the present disclosure defined by the appended claims.

What is claimed is:

1. A virtual commissioning and simulation method for an industrial robot based on digital twin, comprising:
(S1) establishing a digital twin model of the industrial robot;
(S2) establishing a kinematic model of the industrial robot, and performing a forward kinematics analysis and an inverse kinematics analysis on the kinematic model;
(S3) associating the digital twin model of the industrial robot with a signal of the industrial robot to perform virtual commissioning and digital twin-based virtual-real mapping; and
(S4) realizing digital twin visualization of the industrial robot;
wherein step (S1) is performed through steps of:
selecting and inputting a type of the industrial robot to establish a geometric model, or establishing the geometric model based on a geometric dimension of the industrial robot; and
setting material, color, shape and structure of the geometric model to be identical to those of the industrial robot to establish the digital twin model having a visual and structural twin relationship with the industrial robot;
in step (S2), the forward kinematics analysis is performed through steps of:
when all joint angles and link parameters of the industrial robot are determined, determining a pose of an end effector of the industrial robot, which is represented by a homogeneous transformation matrix
$${0}_{6}^{} T ,$$
expressed as:
$${0}_{6}^{} T = {0}_{1}^{} T * {1}_{2}^{} T * {2}_{3}^{} T * {3}_{4}^{} T * {4}_{5}^{} T * {5}_{6}^{} T = [ \text{} \begin{matrix}{n}_{x} & {o}_{x} & {a}_{x} & {p}_{x} \\ {n}_{y} & {o}_{y} & {a}_{y} & {p}_{y} \\ {n}_{z} & {o}_{z} & {a}_{z} & {p}_{z} \\ 0 & 0 & 0 & 1\end{matrix} \text{} ] ; \qquad ( 1 )$$
wherein
$${0}_{6}^{} T$$
represents a pose of a sixth joint coordinate system relative to a base coordinate system;
$${}_{i - 1}^{i} T ( i = 1 , 2 , … , 6 )$$
represents a homogeneous transformation matrix from a (i−1)-th joint coordinate system to an i-th joint coordinate system; (nₓ, n_{y}, n_{z}) represents an X-axis direction of an end effector coordinate system; (oₓ, o_{y}, o_{z}) represents a Y-axis direction of the end effector coordinate system; (aₓ, a_{y}, a_{z}) represents a Z-axis direction of the end effector coordinate system; and (pₓ, p_{y}, p_{z}) represents a position of the end effector;
describing a relative relationship between two adjacent links with four parameters, wherein the four parameters are link length aᵢ, link twist aᵢ, link offset dᵢ and joint angle θᵢ, respectively; the link offset dᵢ represents a distance from an origin of the (i−1)-th joint coordinate system to an intersection point between a Zᵢ₋₁ axis and an Xᵢ axis along the Zᵢ₋₁ axis; the link length aᵢ represents a length of a common normal between an axis of an i-th joint and an axis of a (i+1)-th joint; the link twist aᵢ represents an angle between the axis of the i-th joint and the axis of the (i+1)-th joint on a plane formed by the axis of the i-th joint and the link length aᵢ; the joint angle θᵢ represents a joint angle rotating about the Zᵢ₋₁ axis from an Xᵢ₋₁ axis to the Xᵢ axis; i=1,2, . . . ,6 and an initial value of the joint angle θᵢ represents an angle of each joint of the industrial robot in an initial state;
based on definitions of the link length aᵢ, the link twist aᵢ, the link offset dᵢ and the joint angle θᵢ, establishing a pose transformation from the (i−1)-th joint coordinate system to the i-th joint coordinate system, expressed as a matrix
$${}_{i - 1}^{i} T :$$
$${i - 1}_{i}^{} T = Trans ( {Z}_{i - 1} , {d}_{i} ) Rot ( {Z}_{i - 1} , {θ}_{i} ) Trans ( {X}_{i} , {l}_{i} ) Rot ( {X}_{i} , {α}_{i} ) = [ \text{} \begin{matrix}cos {θ}_{i} & - sin {θ}_{i} & 0 & {α}_{i - 1} \\ sin {θ}_{i} cos {α}_{i - 1} & cos {θ}_{i} cos {α}_{i - 1} & - sin {α}_{i - 1} & - {d}_{i} sin {α}_{i - 1} \\ sin {θ}_{i} sin {α}_{i - 1} & cos {θ}_{i} sin {α}_{i - 1} & - cos {α}_{i - 1} & - {d}_{i} cos {α}_{i - 1} \\ 0 & 0 & 0 & 1\end{matrix} \text{} ] ; \qquad ( 2 )$$
wherein Trans(X, l) represents a translational transformation, indicating a translation of l units along a positive direction of the X-axis; Rot(X, θ) represents a rotational transformation, indicating a rotation of θ degrees about the positive direction of the X-axis; and
obtaining the homogeneous transformation matrix
$${0}_{6}^{} T$$
of the end effector at a key point by combing formulas (1) and (2);
in step (S2), the inverse kinematics analysis is performed through steps of:
reversely solving the joint angle θᵢ through the homogeneous transformation matrix
$${0}_{6}^{} T$$
of the end effector; and
isolating a position parameter expression and an orientation parameter expression of the industrial robot from the formula (2);
wherein first three joint coordinate system transformation matrices in formula (1) are left-multiplied to a left side of the formula (1), expressed as:
$${2}_{3}^{} {T}^{- 1} * {1}_{2}^{} {T}^{- 1} * {0}_{1}^{} {T}^{- 1} * {0}_{6}^{} T = {3}_{4}^{} T * {4}_{5}^{} T * {5}_{6}^{} T ; \qquad ( 3 )$$
performing block-wise comparison on matrices on both sides of formula (3) to obtain an equation set, expressed as:
$$\{ \text{} \begin{matrix}{s}_{1} {p}_{x =} {c}_{1} {p}_{y} \\ {a}_{3} = {s}_{23} ( {d}_{1} - {p}_{z} - {a}_{2} {s}_{2} ) - {c}_{23} ( {a}_{1} + {a}_{2} {c}_{2} - {s}_{1} {p}_{y} - {c}_{1} {p}_{x} ) \\ {d}_{4} = {s}_{23} ( {a}_{1} + {a}_{2} {c}_{2} - {s}_{1} {p}_{y} - {c}_{1} {p}_{x} ) + {c}_{23} ( {d}_{1} - {p}_{z} - {a}_{2} {s}_{2} ) \\ {s}_{4} {s}_{5} = {s}_{1} {a}_{x} - {c}_{1} {a}_{y} \\ {c}_{4} {s}_{5} = {c}_{23} {c}_{1} {a}_{x} + {s}_{23} {s}_{1} {a}_{y} - {s}_{23} {a}_{z} \\ {c}_{5} = {s}_{23} {c}_{1} {n}_{x} - {s}_{23} {c}_{1} {n}_{y} - {c}_{23} {n}_{z} \\ {s}_{5} {s}_{6} = {s}_{23} {c}_{1} {o}_{x} + {s}_{23} {s}_{1} {o}_{y} + {c}_{23} {o}_{yz}\end{matrix} \text{} , \qquad ( 4 )$$
wherein sᵢ=sin θᵢ, cᵢ=cos θᵢ, sᵢⱼ=sin(θᵢ+θj), cᵢⱼ=cos(θᵢ+θⱼ) (i=1,2, . . . ,6) (j=1,2, . . . ,6);
introducing an arctan 2(y/x) function to solve for θ into formula (4) to obtain eight sets of solutions for six joint angles, wherein each equation of the formula (4) is expressed as:
$$a sin {θ}_{i} + b cos {θ}_{i} = c ; \qquad ( 5 )$$
if a, b, and c in formula (5) are continuous, the formula (5) has a solution on the premise of a²+b²>c², expressed as:
$${θ}_{i} = arctan 2 ( c \pm \sqrt{{a}^{2} + {b}^{2} - {c}^{2}} ) - arctan 2 ( b , a ) ; \qquad ( 6 )$$
obtaining the eight sets of solutions by combining the formula (4), the formula (5) and the formula (6); and
expressing a principle for obtaining an optimal solution from the eight sets of solutions as:
$${θ}_{ij} = Min \{ {\sum }_{i = 1}^{3} {( {θ}_{ij} - {θ}_{i}^{′} )}^{2} \} ; \qquad ( 7 )$$
wherein θᵢⱼ represents a j-th solution of an i-th joint, and
$${θ}_{i}^{′}$$
represents an angle of the i-th joint at a previous point.

2. The method of claim 1, wherein step (S3) comprises:
assigning a process attribute to the digital twin model by process simulation, such that each process action of the digital twin model has a corresponding motion process logic;
performing a timing simulation on the process attribute of the industrial robot using a timing editor to plan a sequence of individual processes based on an action sequence table;
enabling a synchronous mapping between the industrial robot and the digital twin model;
establishing a real-time communication between the industrial robot and the digital twin model;
in a case that a control unit of the industrial robot is a communication server, enabling a virtual-to-real mapping, wherein the industrial robot is configured to transmit joint data in real time to the digital twin model, and the digital twin model is configured to receive the joint data and perform steps (S1)-(S2) to achieve a synchronous motion; and
in a case that the control unit of the digital twin model is the communication server, enabling a virtual-to-real control, wherein the digital twin model is configured to send a control command to the control unit of the industrial robot, and the industrial robot is configured to receive and execute the control command.

3. The method of claim 2, wherein the timing simulation is performed based on time.
